(19) United States
(12) Patent Application Publication
(10) Pub. No.: US 2012/0070103 A1
(43) Pub. Date: Mar. 22, 2012

(54) BAG AND A METHOD OF MANUFACTURING A BAG

(75) Inventor: Gary F. Sargin, Green Bay, WI (US)

(73) Assignee: Coating Excellence International LLC, Wrightstown, WI (US)

(21) Appl. No.: 13/236,230

(22) Filed: Sep. 19, 2011

Related U.S. Application Data
(60) Provisional application No. 61/385,199, filed on Sep. 22, 2010.

(51) Int. Cl. B65D 33/16; B31B 41/74

(52) U.S. Cl. 383/61.3; 493/210

(57) ABSTRACT

A method of making a bag by engaging an inverted zipper assembly with a first panel of a polymeric tube, bonding the first panel and the zipper assembly to form a seal therebetween, folding over a stepped end of the tube onto the zipper assembly; and bonding the stepped end and the zipper assembly to form a seal therebetween.

### FIELD OF THE INVENTION

The invention relates to a method of making a bag, and further relates to a bag made by the method.

### BACKGROUND

U.S. Pat. No. 7,165,887 discloses a reclosable bag that is opened and closed by a zipper. Sides of the bag form a continuous loop that covers the entire zipper including a slide actuator of the zipper. The loop is formed from sides of the bag itself, and not from a separate sheet. The loop is removed by tearing along perforated weakened areas of the loop. Due to the perforated weakened areas, the loop is weakened and is unable to reinforce the holding power of the zipper to prevent accidental opening of the zipper. Moreover, the cover completely covers the zipper including the slide actuator, which conceals the zipper from inspection to detect tampering.

U.S. Pat. No. 7,237,953 discloses a bag that is opened and closed by a zipper. Front and rear walls of the bag extend above the zipper and are bonded together. The cover is arranged loosely over the zipper, such that the cover is unable to reinforce the holding power of the zipper. The cover over the entire zipper conceals the zipper from inspection to detect tampering. Such tampering can be performed by cutting through the cover easily and cleanly with a sharp tool to gain access to the zipper and the interior of the bag. Following tampering, the damage to the cover can be repaired by applying glue to conceal that the cover was cut. The repaired cover falsely appears to be wholly intact and untampered with. The repaired cover conceals the entire zipper including the slide actuator from inspection to detect tampering.

U.S. Pat. No. 4,008,850 provides an early description of a bag of tubular form having a stepped end, and further having a front surface and a rear surface adapted to overlap the front surface, between which gussets are interposed, and a stepped end of said tube is closed by being folded against said front surface and adherently secured in position. The adherence of the stepped end would need to be broken in order to open the bag, which prevents resealing the stepped end. It would be desirable to provide a zipper for closing the stepped end. Further it would be desirable to provide a method for assembling a zipper to a stepped end of a tube that is made into a bag.

U.S. Pat. No. 7,237,953 discloses a bag that is opened and closed by a zipper. Front and rear walls of the bag extend above the zipper and are bonded together. The cover is arranged loosely over the zipper, such that the cover is unable to reinforce the holding power of the zipper. The cover over the entire zipper conceals the zipper from inspection to detect tampering. Such tampering can be performed by cutting through the cover easily and cleanly with a sharp tool to gain access to the zipper and the interior of the bag. Following tampering, the damage to the cover can be repaired by applying glue to conceal that the cover was cut. The repaired cover falsely appears to be wholly intact and untampered with. The repaired cover conceals the entire zipper including the slide actuator from inspection to detect tampering.

US 2008/0047228 A1 discloses a bag having a reclosable zipper at one end, and the zipper provides a peel seal and a hard seal, which enable the zipper to resist forces resulting from dropping a filled bag. However, a need exists to provide a bag with a stepped end and to combine the stepped end with a zipper. Further it would be desirable to isolate the zipper from forces endured by the bag, which result from dropping the bag, or rough handling of the bag, while filled with contents. Further it would be desirable to provide a method for making the bag with a stepped end combined with a zipper wherein the zipper is isolated from forces resulting from dropping the bag while filled with contents.

### SUMMARY OF THE INVENTION

The invention includes a method of making a bag, by inverting a zipper assembly and contacting the inverted zipper assembly with a first panel of a polymeric tube, then bonding the first panel and the zipper assembly to form a seal therebetween, then folding over a stepped end of the tube onto the zipper assembly, and then bonding the stepped end and the zipper assembly to form a seal therebetween.

A bag of the invention includes a first panel, a second panel, and side gussets comprising an inner polymeric woven tubular layer and an outer a polymeric non-woven tubular layer. The bag has a stepped end. The stepped end includes portions of the side gussets of the composite tube being longer than the first panel and a portion of the second panel extending longer than the side gussets and providing a flap. An inverted zipper assembly is bonded to the first panel to form a seal therebetween, and the stepped end is folded over a second flange of the zipper assembly. The stepped end is bonded to the second flange to form a seal therebetween.

### BRIEF DESCRIPTION OF THE DRAWINGS

Embodiments of the invention will now be described by way of example with reference to the accompanying drawings.

FIG. 1 is an isometric view of a bag having a reclosable fastener assembly and a hood that augments the holding power of the fastener assembly.

FIG. 1A is a side view of the bag of FIG. 1.

FIG. 1B is a fragmentary section view of the reclosable fastener assembly disclosed by FIG. 1.

FIG. 1C is an isometric view of a tube for making the bag of FIG. 1.

FIG. 2 is a front view of the tube of FIG. 1C with the reclosable fastener assembly disclosed by FIG. 1 being attached to the first panel of the tube.

FIG. 3 is a view similar to FIG. 2, with the second panel of the tube being folded over and attached to the reclosable fastener assembly disclosed by FIG. 1.

### DETAILED DESCRIPTION

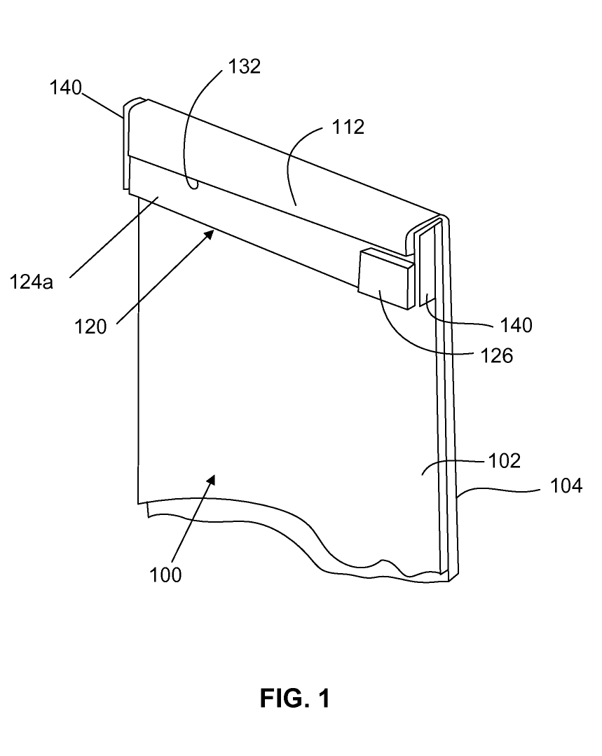

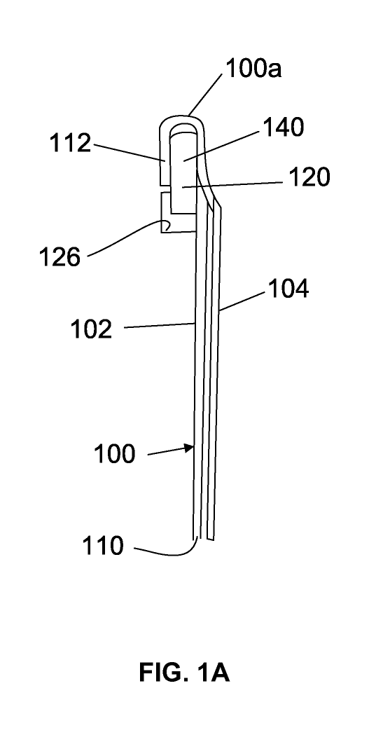

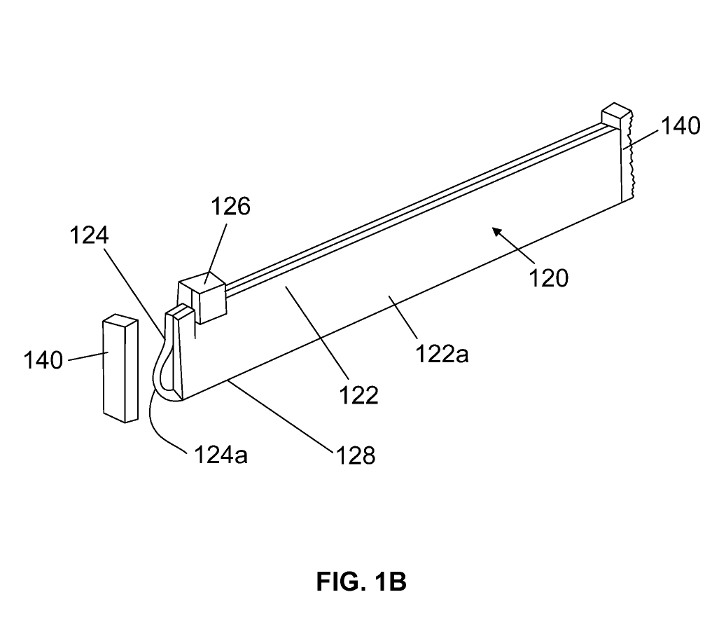

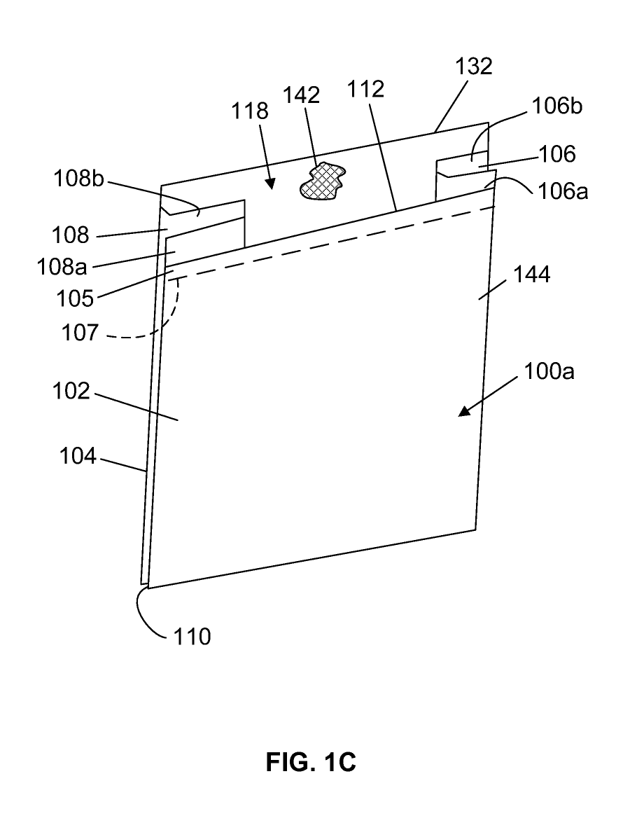

FIG. 1 discloses a package in the form of a bag 100, which begins as a tube 100a, FIG. 1C, which is formed with a first panel 102, a second panel 104 and opposite side panels 106, 108. The side panels 106, 108 are also referred to as side gussets 106, 108. The side gussets 106, 108 are folded flat, such that the tube 100a is folded flat for shipment and handling. The bag 100 and the tube 100a includes an elongated bottom opening 110 through which contents are received to fill the bag 100. After the bag 100 has been filled with contents, the bottom opening 110 can be closed and sealed, for example, by sewing, adhesives or adhesive tape.

Alternatively the bottom opening 110 is formed as a stepped end, which is closed by pinch closing after filling the bag with contents, followed by folding the bag on itself, and then sealed. FIG. 1C discloses a stepped end 112 of the tube 100a, which is formed at one end or can be formed at both ends of the tube 100a. The stepped end 112 will now be described at an opening 118 in the tube 100a. The opening 118 extends transversely along the top end or stepped end 112 of the tube 100a. At the stepped end 112, the side gussets 106, 108 extend beyond the first panel 102, and are longer than the first panel 102 at the stepped end 112. The second panel 104 extends beyond the side gussets 106, 108 at the stepped end 112, and provides a hood or flap 132 at the stepped end 112.

An alternative embodiment includes a panel portion 105 of the first panel 102, which is at an edge of the first panel 102 adjacent the opening 118. A line 107 is a reference line parallel to the edge and demarcates the panel portion 105 separate from a remainder of the first panel 102. Alternatively, the line 107 can comprise a fold line. Alternatively, the bag 100 is creased to provide a crease along the fold line.

In FIG. 1C, the side gusset 106 has a first portion 106a connected by a fold in the tube 100a to a second portion 106b. Similarly, the side gusset 108 has a first portion 108a connected by a fold in the tube 100a to a second portion 108b. The second portions 106b, 108b are longer than the first portions 106a, 106b. Alternatively, the second portions 106b, 108b have the same length as the first portions 106a, 106b.

In FIG. 1C, an embodiment of the tube 100a which becomes the bag 100 comprises the first panel, the second panel and the side gussets, which are comprised of a tubular interior woven layer 142, for example, a woven compostable polypropylene, PP, layer, which is an interior layer, a small portion of which is disclosed in FIG. 1C for purposes of illustration, and an outer, polymeric non-woven tubular layer. The woven layer 142 is in the form of a single layer tube, such that the tube has an overlap seam or alternatively is a seamless tube without an overlap seam. In a preferred embodiment the woven layer 142 is woven as seamless tube. Bags 100 are compostable, for example, when made with PP resins to which mineral additives, such as, calcium carbonate render the bags 100 compostable. According to an embodiment, either or both the woven layer 142 and the exposed sheet or film of the exterior layer are made of propylene PP based copolymers.

The non-woven outer polymer layer 144 comprises a single polymer layer in the form of a single sheet or film. Alternatively, the non-woven outer polymer layer 144 is in the form of two or more non-woven polymer layers laminated together to provide a composite outer layer 144. A composite outer layer 144 will have a polymer inner sheet or film facing the woven layer 142, and a reverse printed polymer outer sheet or film facing an exterior of the tube 110a before forming the tube 100a into the bag 100 with the reverse printed surface facing the inner sheet or film and being protected by the inner sheet or film. Further, the inner sheet or film covers the woven layer 142 as a whole and protects the woven layer 142 as a whole. Further, according to alternative preferred embodiments, each sheet or film for the outer layer 144 is formed into a seamless tube or formed with seams to make a seamed tube. For example, the stepped end 112 is formed by cutting the tube 100a to the shape of the stepped end 112.

Alternatively, the stepped end 112 is formed by cutting one or more flat sheets or films, followed by overlapping the one or more sheets or films along overlapped seams thereof, and laminating the one or more one or sheets or films together to form a flexible cylindrical tube 100a having the stepped end 112, and one or more seams which are bonded together and sealed closed.

In FIG. 1C, the stepped end 112 will now be described at an opening 118 in the tube 100a, which will become an opening 118 of the bag 100. The opening 118 extends transversely along the top end or stepped end 112 of the tube 100a. The stepped end 112 includes portions of the side gussets 106, 108 which extend beyond the first panel 102, and are longer than the first panel 102 at the stepped end 112. The stepped end 112 includes a portion of the second panel 104 which extends beyond the side gussets 106, 108 and provides a hood or flap 132 of the stepped end 112. In FIG. 1C, the side gusset 106 has a first portion 106a connected by a fold to a second portion 106b. Similarly, the side gusset 108 has a first portion 108a connected by a fold to a second portion 108b. The second portions 106b, 108b are longer than the first portions 106a, 106b. Alternatively, the second portions 106b, 108b can be cut to the same lengths as the first portions 106a, 106b.

An imaginary reference line 107 extends across the first panel 102, and is used as a reference line to locate the zipper assembly in preparation for attaching the zipper assembly to the first panel 102. The location of the reference line 107 varies, depending upon the dimensions of the zipper assembly. Alternatively, the line 107 can comprise a fold line 107 along which the bag 100 is folded. Further, alternatively, the tube 100a is creased to provide a crease along the fold line 107 in the tube 100a and thereafter the crease is present in the bag 100.

With reference to FIG. 1B, an embodiment of a reclosable fastener assembly 120, or zipper assembly 120, comprises an elongated first fastening member 122 and an elongated second fastening member 124 that releasably interlock by displacement of a sliding actuator 126 over the fastening members 122, 124 to close and seal the opening 118. The fastening members 122 and 124 are separate or, alternatively, are connected together temporarily along a perforation line 128, and later separated along the perforation line 128. With reference to FIG. 1, the sliding actuator 126 is at an end of the reclosable fastener assembly 120 to close the opening 18, while the bag is folded flat and ready for shipping and handling. Sliding the actuator 126 in an opposite direction will unlock the first fastening member 122 and the second fastening member 124 from each other, which allows separation of the fastening members 122 and 124 to open the opening 118 at the bag end 112. In FIG. 1B, end seals 140 seal a crevice between ends of the fastening members 122 and 124 and provide mechanical stops 140 at opposite ends of the fastening members 122 and 124 to limit sliding displacement of the actuator 126 end-to-end along the fastening members 122 and 124. As disclosed by FIG. 1, the sliding actuator 126 is moved to a position which fully closes the bag end 112, wherein the actuator 126 engages a mechanical stop 140 to limit its sliding displacement along the fastening members 122 and 124. In FIG. 1B the elongated first fastening member 122 has an elongated flange 122a. Similarly, the elongated second fastening member 124 has an elongated flange 124a. The flanges 122a, 124a typically comprise low density molecular weight polyethylene, LDPE.

In FIG. 1B, another embodiment of the zipper assembly 120 includes the flanges 122a, 124a at their bottom edges being connected together temporarily along a perforation line 128, to be later separated by tearing along the perforation line 128 in order to open the zipper assembly 120 for obtaining access to a bag opening 118, FIG. 1C.

Another embodiment of the zipper assembly 120 includes the flanges 122a, 124a being spreadable apart from each other, for example, by having one of the end seals 140 removed initially from the ends of the flanges 122a, 124a, or both end seals 140 removed initially. With one end seal 140 removed, or both end seals 140 removed, the flanges 122a, 124a are attached to the first panel 102 and the second panel 104, respectively, according to a method to be described. Thereafter, the end seals 140 are assembled to the ends of the flanges 122a, 124a and glued in place to seal the ends of the zipper assembly 120.

A description follows to describe assembly of the reclosable fastener assembly or zipper assembly 120 to the tube 100a in order to manufacture a bag 100, wherein the bag 100 is sealed by an adhesive bond of the woven layer 142 and the non-woven layer 144 with the LDPE flanges 122a and 124a.

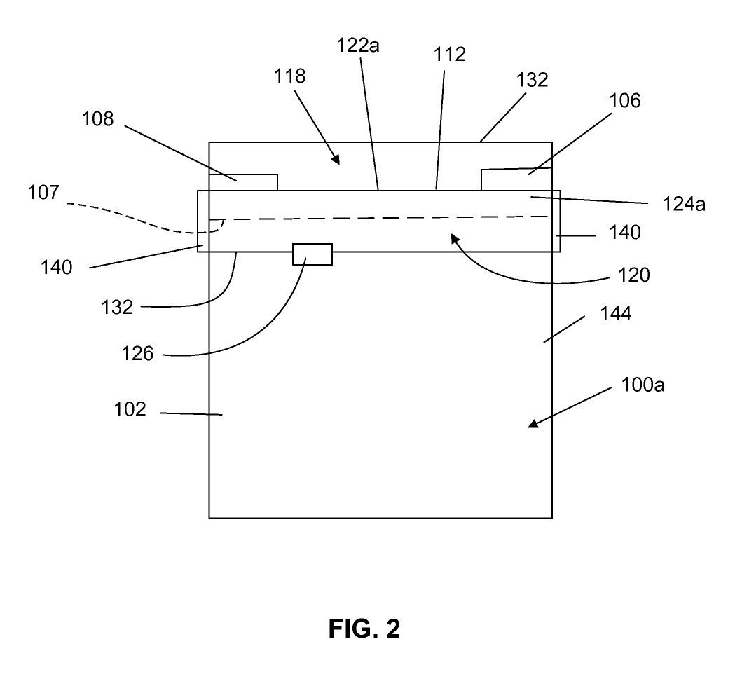

According to a method step (a), the reclosable fastener assembly 120 in FIG. 1B is inverted in FIG. 2, and the inverted flange 122a overlaps the first panel 102 of the tube 100a, while a first performance of method step (a) includes, an edge of the inverted flange 122a in aligned registration with the edge of the first panel 102 adjacent to the stepped end 112 and adjacent to the opening 118. A first embodiment of the stepped end 112 includes: the side gussets 106, 108, which are longer than the first panel 102, and the flap 132, which is longer than the side gussets 106, 108.

A method step (b) includes sealing the first panel 102 of the tube 100a to the inverted flange 122a at the bag opening 118. According to the method step (b), before the flange 122a is in contact with the first panel 102, they are spaced apart by a narrow gap while hot air is applied, which heats the surface of the flange 122a and the surface of the first panel 102, until the surface of the LDPE material of the flange 122a attains an adhesive state, and the surface of the first panel 102 is heated to its heat activation temperature at which temperature the propylene PP based copolymers, for example, Vistamaxx™ resins attain an adhesive state. Hot air at a temperature of 800° F. is suitable for melting the surface of the stepped end 112, which has a surface layer of a propylene PP based copolymer other than Vistamaxx™ resins. Then, the melted surfaces of the flange 122a and the first panel 102 are engaged, which forms an adhesive-to-adhesive melt-bond between the flange 122(a) and the first panel 102. Hot air at a temperature of 800° F. is suitable for melting the surface of the first panel 102, which has a surface layer of a propylene PP based copolymer other than Vistamaxx™ resins. The adhesive-to-adhesive melt-bond seals the first panel 102 of the tube 100a to the flange 122a at the bag opening 118.

In an alternative embodiment, the tube 100a is foldable along the line 107, and still further, the tube 100a is provided with a crease along the line 107. The inverted flange 122a is bonded to the first panel 102 excluding the portion 105 of the first panel 102, which avoids bonding the flange 122a to the portion 105, and avoids bonding the flange 122a to the line 107, and avoids bonding the flange 122a to the crease, if present.

According to another embodiment of the method step (b), the inverted flange 122a is in contact with the first panel 102, and a hot bar of heated metal is applied thereon, preferably against the bag material of the first panel 102, which heats the surface of the flange 124a and the surface of the first panel 102, until the surface of the LDPE material of the flange 122a attains an adhesive state, and the surface of the first panel 102 is heated to its heat activation temperature. The melted surfaces of the flange 122a and the first panel 102 are engaged, which forms an adhesive-to-adhesive melt-bond between the flange 122(a) and the first panel 102.

According to another embodiment of the method step (b), the inverted flange 122a is in contact with the first panel 102, and hot air or ultrasonic energy is applied thereto in order to heat surfaces of the first panel 102 and the flange 122a, which are in contact, until the surface of the first panel 102 is heated to its heat activation temperature at which temperature the propylene PP based copolymers, for example, Vistamaxx™ resins attain an adhesive state. Hot air at a temperature of 800° F. is suitable for melting the surface of the stepped end 112, which has a surface layer of a propylene PP based copolymer other than Vistamaxx™ resins. And further, the surface of the LDPE material of the flange 122a attains an adhesive state, in order to form an adhesive-to-adhesive melt-bond between the first panel 102 and the inverted flange 122a. The adhesive-to-adhesive melt-bond seals the tube 100a to the flange 122a at the bag opening 118.

In an embodiment of the zipper assembly 120 wherein one end seal 140 is removed, or both end seals 140 are removed, the flanges 122a and 124a are free for separating at least partially apart from each other with an air space between them, while the inverted flange 122a is melt-bonded to the first panel 102. As a result, the flanges 122a and 124a avoid being melt-bonded to each other during the application of heated air or ultrasonic energy. After sealing the first panel 102 and the stepped end 112 to the flanges 102a and 104a, respectively, the end seals 140 are assembled to the ends of the flanges 102a and 104a to seal a crevice between the flanges.

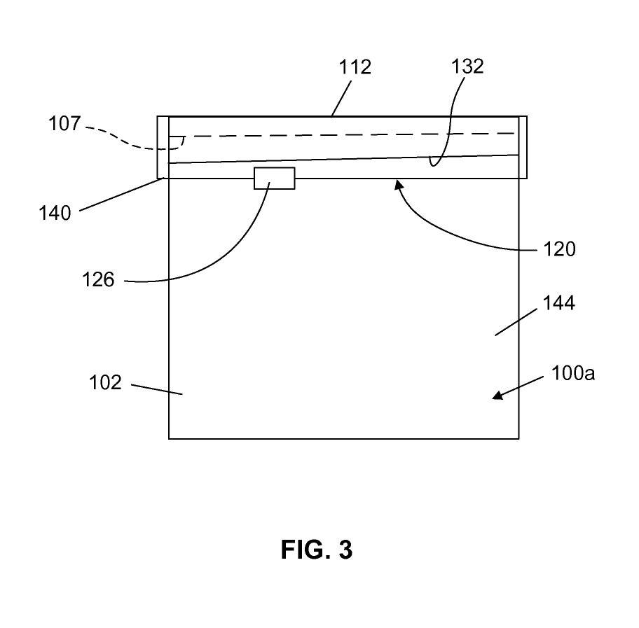

With reference to FIG. 3, a method of assembling the reclosable fastener assembly 120 to the stepped end 112 of the tube 100a will now be described. A method step (c) includes overlapping the flange 124a with the stepped end 112 of the tube 100a. With reference to FIGS. 2 and 3, a performance of the method step (c) includes the step of folding over the stepped end 112 of FIG. 2, so as to overlap the flange 124a, as disclosed in FIG. 3. FIGS. 1 and 1A disclose the stepped end 112 is folded by being bent over.

In FIG. 1C, a first embodiment of the stepped end 112 includes the flap 132, which is longer than the side gussets 106, 108. The gusset second portions 106b, 108b are either longer than the first portions 106a, 106b, or the gusset second portions 106b, 108b have the same length as the first portions 106a, 106b.

A method step (d) includes sealing the stepped end 112 of the tube 100a to the flange 124a at the bag opening 118. The method step (d) includes a step of forming an adhesive-to-adhesive melt-bond between the flange 124a and the stepped end 112. An embodiment of the method step (d) includes a step of applying hot air to form an adhesive-to-adhesive melt-bond between the flange 124a and the stepped end 112. Before the flange 124a is in contact with the stepped end 112, they are spaced apart by a narrow gap while hot air heats the surface of the flange 124a and the surface of the stepped end 112, until the surface of the LDPE material of the flange 124a attains an adhesive state, and the surface of the stepped end 112 is heated to its heat activation temperature at which temperature the propylene PP based copolymers, for example, Vistamaxx™ resins attain an adhesive state. Hot air at a temperature of 800° F. is suitable for melting the surface of the stepped end 112, which has a surface layer of a propylene PP based copolymer other than Vistamaxx™ resins. Then, the melted surfaces of the flange 124a and the stepped end 112 are engaged, which forms an adhesive-to-adhesive melt-bond between the flange 124a and the stepped end 112. The adhesive-to-adhesive melt-bond seals the stepped end 112 of the tube 100a to the flange 124a at the bag opening 118.

In an embodiment of the zipper assembly 120 wherein one end seal 140 is removed, or both end seals 140 are removed, the flanges 122a and 124a are free for separating at least partially apart from each other with an air space between them, while the inverted flange 122a is melt-bonded to the first panel 102. As a result, the flanges 122a and 124a avoid being melt-bonded to each other during the application of heated air or ultrasonic energy.

An alternative embodiment of method step (d) includes, engaging the flange 124a and the stepped end 112, and applying thereon a hot bar of heated metal, preferably against the bag material of the stepped end 112, which heats the surface of the flange 124a and the surface of the stepped end 112, until the surface of the LDPE material of the flange 124a attains an adhesive state, and the surface of the flap 132 is heated to its heat activation temperature. The melted surfaces of the flange 124a and the stepped end 112 are engaged, which forms a melt-bond between the flange 124(a) and the stepped end 112.

According to another embodiment of method step (d), while the flange 124a engages the stepped end 112 to form an interface therebetween, energy in the form of ultrasonic energy is applied which heats the surface of the flange 124a and the surface of the stepped end 112 at the interface, until the surface of the LDPE material of the flange 124a attains an adhesive state, and the surface of the flap 132 is heated to its heat activation temperature at which temperature the propylene PP based copolymers, which form a melt-bond between the flange 124(a) and the stepped end 112. The melt-bond seals the stepped end 112 of the tube 100a to the flange 124a at the bag opening 118.

In an embodiment of the zipper assembly 120 wherein one end seal 140 is removed, or both end seals 140 are removed, the flanges 122a and 124a are free for separating the flanges 122a and 124a at least partially apart from each other with an air space between them, while the flange 124a is melt-bonded to the stepped end 112. As a result, the flanges 122a and 124a avoid being melt-bonded to each other during the application of hot air, hot bar or ultrasonic energy. After, the first panel 102 and the stepped end 112 are sealed to the flanges 122a and 124a, respectively, the end seals 104 are assembled in order to seal respective ends of the flanges 122a and 124a.

According to an alternative embodiment of the method, the reclosable fastener assembly 120 in FIG. 1B is inverted in FIG. 2, and the inverted flange 122a is placed to overlap the first panel 102 of the tube 100a, according to method step (a). Then, according to method step (c), described above, the stepped end 112 is folded over to overlap the flange 124a, as disclosed in FIG. 3. Then, according to method step (d), described above, hot air, hot bar or ultrasonic energy forms an adhesive-to-adhesive melt-bond between the stepped end 112 and the flange 124a. And contemporaneously or subsequently, hot air, hot bar or ultrasonic energy, according to method step (b), described above, which forms an adhesive-to-adhesive melt-bond between the first panel 102 and the inverted flange 122a.

In an embodiment of the zipper assembly 120 wherein one end seal 140 is removed, or both end seals 140 are removed, the flanges 122a and 124a are free to be separated at least partially apart from each other with an air space between them, while the flange 122a is melt-bonded to the first panel 102. As a result, the flanges 122a and 124a avoid being melt-bonded to each other during the application of heat, hot bar or ultrasonic energy.

An alternative embodiment of the bag comprises a PP woven layer and an LDP non-woven layer which utilize layers of heat activated adhesive to engage and form an adhesive bond. Suitable adhesive materials are disclosed in US 2010/0158418 A1 and 2010/0154362 A1 and 2010/0189380 A1 expressly incorporated herein by reference in their entireties. An embodiment of the flanges 122a and 124a includes respective layers of heat activated adhesive material on surfaces thereof which are to be melt-bonded to the first panel 102 and the stepped end, respectively. Embodiments of the first panel 102 and the stepped end 112 include respective layers of heat activated adhesive material on surfaces thereof which are to be melt-bonded to the flanges 122a and 124a, respectively. Hot air, hot bar or ultrasonic energy is applied, as described above, and the surfaces of the adhesive materials are heated to their melted adhesive states at a temperature below the melt temperature of the PP and LDPE materials, wherein the adhesive material on the flange 122a forms an adhesive-to-adhesive melt-bond with the adhesive material on the first panel 102, and the adhesive material on the flange 124a forms an adhesive-to-adhesive melt-bond with the adhesive material on the stepped end 112. The adhesive-to-adhesive melt-bond of the flange 122a and the first panel 102 forms a seal at the stepped end 112 of the tube 100a and the resulting bag 100. The adhesive-to-adhesive melt-bond of the flange 124a and the second panel 104 forms a seal at the stepped end 112 of the tube 100a and the resulting bag 100.

As a result of performing alternative sequences of the above-described method steps, the bag opening 118 is sealed to the reclosable fastener assembly 120, or zipper assembly, which results in the bag 100, FIG. 1.

According to the invention, a stepped end 112 sealed with a reclosable fastener assembly or zipper assembly 120 is disclosed. The bag 100 results from sealing the tube 100a to the zipper assembly 120. In FIG. 1, the bag 100 is folded for shipping and handling. An open end 110 of the bag 100 is used for filling the bag 100 with contents, after which the end 110 is closed and sealed.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as disclosed in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Patents and patent applications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of making a bag, comprising:
overlapping an inverted zipper assembly with a first panel of a polymeric tube;
bonding the zipper assembly and the first panel to form a seal therebetween;
folding over a stepped end of the tube to overlap the inverted zipper assembly; and
bonding the inverted zipper assembly and the stepped end to form a seal therebetween.

2. The method of claim 1, comprising:
bonding the inverted zipper assembly to a portion of the first panel, wherein the portion of the first panel is adjacent the stepped end.

3. The method of claim 1, comprising:
creasing the tube to provide a crease; and
bonding the zipper assembly to a portion of the first panel, wherein the portion of the first panel is between the crease and an edge of the first panel adjacent the stepped end.

4. The method of claim 1, comprising:
melting surfaces of the first panel and the zipper assembly with hot air, followed by bonding the zipper assembly and the first panel to form a seal therebetween; and
melting surfaces of the stepped end and the zipper assembly with hot air, followed by bonding zipper assembly and the stepped end to form a seal therebetween.

5. The method of claim 1, comprising:
melting surfaces of the first panel and the zipper assembly with a hot bar and bonding the zipper assembly and the first panel to form a seal therebetween; and
melting surfaces of the stepped end and the zipper assembly with a hot bar and bonding the zipper assembly and the stepped end to form a seal therebetween.

6. The method of claim 1, comprising:
contacting the surfaces of the first panel and the zipper assembly and melting the surfaces of the first panel and the zipper assembly with ultrasonic energy to bond and form a seal therebetween; and
contacting the surfaces of the stepped end and the zipper assembly and melting the surfaces of the stepped end and the zipper assembly with ultrasonic energy to bond and form a seal therebetween.

7. The method of claim 1, comprising:
bonding the zipper assembly and the first panel prior to folding over the stepped end.

8. The method of claim 1, comprising:
folding over the stepped end before bonding the zipper assembly and the first panel, followed by bonding the zipper assembly and the first panel and bonding the zipper assembly and the stepped end.

9. The method of claim 1, comprising:
folding over the stepped end before bonding the zipper assembly and the first panel, followed by bonding the zipper assembly to both the first panel and the stepped end.

10. A bag, comprising:
a tube having a polymeric woven tubular layer enclosed by a polymeric non-woven tubular layer, and having a first panel and a stepped end, and the stepped end includes side gussets of the composite tube being longer than the first panel and a second panel of the composite tube having a flap extending longer than the side gussets;
an inverted zipper assembly having an inverted first flange bonded to the first panel to form a seal therebetween, and
the stepped end being folded over and bonded to an inverted second flange of the zipper assembly to form a seal therebetween.

11. The bag of claim 10, wherein the first flange is bonded to a portion of the first panel, wherein the portion of the first panel is adjacent to the stepped end.

12. The bag of claim 10 wherein the first panel is creased and the first inverted flange of the zipper assembly is bonded to a portion of the first panel, wherein the portion of the first panel is between the crease and an edge of the first panel adjacent to the stepped end.
